(19) United States
(12) Patent Application Publication
(10) Pub. No.: US 2011/0236072 A1
(43) Pub. Date: Sep. 29, 2011

(54) ELECTRON EMITTING ELEMENT AND METHOD FOR PRODUCING THE SAME

(76) Inventors: Yasuo Imura, Osaka (JP); Hiroyuki Hirakawa, Osaka (JP); Ayae Nagaoka, Osaka (JP); Kanako Hirata, Osaka (JP); Tadashi Iwamatsu, Osaka (JP)

(21) Appl. No.: 13/069,852

(22) Filed: Mar. 23, 2011

(30) Foreign Application Priority Data
Mar. 26, 2010 (JP) 2010-72956

(51) Int. Cl. G03G 15/02; H01J 9/04; H01T 23/00; H01J 9/02; H05B 41/00; G01J 1/42

(52) U.S. Cl. 399/168; 313/310; 361/233; 445/46; 315/326; 250/393

(57) ABSTRACT

The present invention provides an electron emitting element, comprising: a first electrode; an insulating fine particle layer formed on the first electrode; and comprising first insulating fine particles and second insulating fine particles larger than the first insulating fine particles, a surface of the insulating fine particle layer having a projection formed from the second insulating fine particles, and a second electrode formed on the insulating fine particle layer, wherein when a voltage is applied between the first electrode and the second electrode, electrons provided from the first electrode are accelerated in the insulating fine particle layer to be emitted from the second electrode via the projection.

### CROSS-REFERENCE TO RELATED APPLICATION

This application is related to Japanese Patent Application No. 2010-072956 filed on Mar. 26, 2010, whose priority is claimed and the disclosure of which is incorporated by reference in its entirety.

### BACKGROUND OF THE INVENTION

1. Field of the Invention

The present invention relates to an electron emitting element for emitting electrons by application of a voltage and a method for producing the same.

2. Description of the Related Art

Electron emitting elements comprising a Spindt-type electrode and a carbon nanotube (CNT) electrode are known as conventional electron emitting elements. Applications of such conventional electron emitting elements to, for example, the field of FED (Field Emission Display) have been studied. Such electron emitting elements are caused to emit electrons by tunnel effect resulting from an intense electric field of approximately 1 GV/m that is formed by application of a voltage to a pointed section.

However, these two types of electron emitting elements have the intense electric field in the vicinity of a surface of an electron emitting section. Accordingly, electrons emitted obtain a large amount of energy due to the electric field to be more likely to ionize gas molecules. Cations generated due to the ionization of gas molecules are accelerated toward and collide with a surface of the element due to the intense electric field. This causes a problem of breakdown of the element due to sputtering. Further, ozone is generated before ions are generated, because oxygen in the atmosphere has dissociation energy that is lower than ionization energy. Ozone is harmful to human bodies and oxidizes various substances because of its strong oxidizing power. This causes a problem in that members around the element are damaged. In order to prevent this problem, the members around the element are limited to materials having high resistance to ozone.

With such background, MIM (Metal Insulator Metal) type and MIS (Metal Insulator Semiconductor) type electron emitting elements have been developed as other types of electron emitting elements. These electron emitting elements are surface-emission-type electron emitting elements, each of which accelerate electrons by utilizing quantum size effect and an intense electric field in the element so that electrons are emitted from a flat surface of the element. These electron emitting elements do not require an intense electric field outside the elements, because the electrons accelerated in an electron acceleration layer in the elements are emitted to the outside. The MIM type and MIS type electron emitting elements can therefore overcome the problem of breakdown of the element by sputtering due to ionization of gas molecules and the problem of ozone generation, which are likely in the Spindt-type, CNT type and BN type electron emitting elements.

However, such electron emitting elements are generally prone to pin holes or dielectric breakdown. Against this problem, there is a known technique to prevent the pinholes and the dielectric breakdown by using an insulating film having fine particles of a metal or the like in such electron emitting elements. For example, an MIM type electron emitting element provided with an insulator containing fine particles of a metal or the like between two sheets of electrodes opposed to each other is known (see Japanese Unexamined Patent Publication No. HEI 1(1989)-298623, for example).

While these electron emitting elements have an insulating film containing fine particles of a metal or the like as its component, however, the insulating film may cause decrease in the amount of electrons being emitted from the electron emitting element in some cases where the film is so thick that the electric resistance thereof increases. On the other hand, the insulating film may easily cause dielectric breakdown in some cases where the insulating film is so thin that it is difficult to prepare a uniform insulating film. As a result, it will be difficult to apply a sufficient voltage to the electron emitting element, and therefore the electron emitting element may not be able to emit sufficient electrons. Thus, development of an electron emitting element that can emit sufficient electrons and that is less prone to dielectric breakdown has been desired.

### SUMMARY OF THE INVENTION

In view of the above-described circumstances, the present invention has been achieved to provide an electron emitting element that can emit sufficient electrons and that is less prone to dielectric breakdown.

According to an aspect of the present invention, there is provided an electron emitting element, comprising: a first electrode; an insulating fine particle layer formed on the first electrode and comprising first insulating fine particles and second insulating fine particles larger than the first insulating fine particles, a surface of the insulating fine particle layer having a projection formed from the second insulating fine particles; and a second electrode formed on the insulating fine particle layer, wherein when a voltage is applied between the first electrode and the second electrode, electrons provided from the first electrode are accelerated in the insulating fine particle layer to be emitted from the second electrode via the projection.

In order to achieve the above-described object, the inventors of the present invention made intensive studies and, as a result, found that an electron emitting element would be able to emit electrons even when no conductive fine particles such as metal fine particles are contained in an electron acceleration layer provided between electrodes of the electron emitting element by employing an insulating fine particle layer composed of insulating fine particles as the electron acceleration layer.

Furthermore, the inventors of the present invention focused on the fact that the size of the insulating fine particles in the insulating fine particle layer affects the flowability of the current. Then, the inventors of the present invention found that the current pathway in the insulating fine particle layer would be limited and the amount of electrons being emitted would increase when a projection derived from larger insulating fine particles is formed on the insulating fine particle layer, to reach completion of the present invention.

The present invention can provide an electron emitting element that can emit sufficient electrons and that is less prone to dielectric breakdown.

### BRIEF DESCRIPTION OF THE DRAWINGS

FIG. 1 is a schematic view illustrating a configuration of an electron emitting element according to an embodiment of the present invention;

FIG. 2 is a sectional view of the electron emitting element taken along a line A-A in FIG. 1;

FIG. 3 is a drawing illustrating a measurement system for an electron emission experiment;

FIG. 4 is a drawing illustrating an example of a charging device including an electron emitting element of the present invention;

FIG. 5 is a drawing illustrating an example of an air blowing device including an electron emitting element of the present invention and a cooling device equipped with the air blowing device; and

FIG. 6 is a drawing illustrating another example of the air blowing device including an electron emitting element of the present invention and the cooling device equipped with the air blowing device.

### DESCRIPTION OF THE PREFERRED EMBODIMENTS

An electron emitting element of the present invention comprises: a first electrode; an insulating fine particle layer formed on the first electrode and comprising first insulating fine particles and second insulating fine particles larger than the first insulating fine particles, a surface of the insulating fine particle layer having a projection formed from the second insulating fine particles; and a second electrode formed on the insulating fine particle layer, wherein when a voltage is applied between the first electrode and the second electrode, electrons provided from the first electrode are accelerated in the insulating fine particle layer to be emitted from the second electrode via the projection.

Since a layer for accelerating electrons provided from the first electrode (in the present specification, also referred to as electron acceleration layer) is composed of insulating fine particles in the present invention, it is not necessary to consider the dispersibility (for example, aggregation) of conductive fine particles in the electron acceleration layer, unlike an MIM-type electron emitting element provided with an insulator containing fine particles of a metal or the like. Even when the electron acceleration layer is formed thin, therefore, the electron emitting element of the present invention is less prone to dielectric breakdown.

In addition, since projections derived from the second insulating fine particles are formed on a surface of the insulating fine particle layer serving as the electron acceleration layer on a side of the second electrode, the current pathway is limited even when the electron acceleration layer is formed thick. Accordingly, the electron emitting element can emit sufficient electrons. In order for a conventional MIS element to emit a sufficient amount of electrons, it was necessary to apply a voltage of approximately 100 V. Meanwhile, the electron emitting element of the present invention can emit a comparable amount of electrons by application of a voltage of approximately 20 V.

In addition, the configuration of the electron acceleration layer is simple as being composed of at least two kinds of insulating fine particles. The electron emitting element can therefore be produced easily. Furthermore, since less materials are needed to form the electron acceleration layer compared with the MIM-type electron emitting element provided with an insulator containing fine particles of a metal or the like, the electron emitting element of the present invention can be produced at low production cost.

The first electrode is a conductor or a semiconductor for applying a voltage to the insulating fine particle layer, and may be a single structure or a structure consisting of a plurality of structures. For example, the first electrode may be a metal plate or a metal film formed on an insulator (such as an aluminum film formed on a glass substrate). The first electrode includes a so-called electrode substrate.

In the electron emitting element of the present invention, in addition to the above-described configuration, the insulating fine particle layer consists of a first part formed from the first insulating fine particles and a second part formed from the first and second insulating fine particles, and the projections are formed in the second part.

Here, the size of the projections means a width and a height based on a surface of the part formed from the first insulating fine particles in the insulating fine particle layer, on the assumption that the surface of the part formed from the first insulating fine particles in the insulating fine particle layer is the surface of the insulating fine particle layer.

In an embodiment of the present invention, in addition to the above-described configuration of the present invention, the first insulating fine particles may have an average particle diameter of 7 nm to 400 nm. This is because when the average particle diameter is 7 nm or more, the first insulating fine particles will be easily dispersed in a solvent and applied to form the insulating fine particle layer; and when the average particle diameter is 400 nm or less, the thickness of the insulating fine particle layer being formed will be easily controlled.

Preferably, in an embodiment of the present invention, the first part has a layer thickness of 1 μm or less. Such a configuration prevents the resistance of the insulating fine particle layer from being too high and allows the electron emitting element to emit a sufficient amount of electrons. In addition, such a configuration allows production of an electron emitting element regardless of a problem of decrease in the dispersibility of the insulating fine particles in a dispersion of the insulating fine particles and a problem of gelation of the dispersion that arise when the dispersion of the insulating fine particles is applied to form the insulating fine particle layer. Furthermore, it is possible to avoid a problem of the solvent of the dispersion to remain on the insulating fine particle layer after the application. Thus, the layer thickness of the first part formed from the first insulating fine particles within the above-specified range allows formation of a more uniform layer and stable production of an electron emitting element.

Preferably, the first part formed from the first insulating fine particles has a layer thickness larger than the average particle diameter of the first insulating fine particles. It is believed that the thinner the insulating fine particle layer is, the higher the flowability of the current is. When the part formed from the first insulating fine particles has a layer thickness substantially the same as the average particle diameter, the first electrode will be covered with the first insulating fine particles substantially uniformly to have no space where no first insulating fine particle exists. It is therefore preferable that the part formed from the first insulating fine particles has a layer thickness larger than the average particle diameter of the first insulating fine particles.

More preferably, the part formed from the first insulating fine particles has a layer thickness larger than three particles of the first insulating fine particles closest-packed, that is, 2.4 times the average particle diameter of the first insulating fine particles.

The flowability of the current is decreased in the part formed from the first insulating fine particles, and the flowability of the current is increased in the projections formed from the first and second insulating fine particles thereby to concentrate the current in the projections and improve the electron emission efficiency.

It is therefore preferable that the part formed from the first insulating fine particles has a layer thickness larger than 2.4 times the average particle diameter of the first insulating fine particles.

In an embodiment of the present invention, in addition to the above-described configuration of the present invention, the second insulating fine particles may have an average particle diameter of 9 or more times the average particle diameter of the first insulating fine particles, for example.

In an embodiment of the present invention, in addition to the above-described configuration of the present invention, the first and second insulating fine particles may be particles formed of at least one insulator of SiO₂, Al₂O₃ and TiO₂.

The first and second insulating fine particles may be particles formed of a metal oxide or a metal nitride, but when they are particles formed of at least one insulator of SiO₂, Al₂O₃ and TiO₂, these insulators have high insulating properties, and therefore the electric resistance of the insulating fine particle layer can be adjusted to any range by adjusting the content of these insulators.

In an embodiment of the present invention, in addition to the above-described configuration of the present invention, the first and second insulating fine particles may be particles containing an organic polymer. For example, they may be particles containing a material such as styrene, divinylbenzene and silicone.

In an embodiment of the present invention, in addition to the above-described configuration of the present invention, the insulating fine particle layer may be a layer formed by applying a dispersion of the first and second insulating fine particles that are surface-treated. The surface treatment may be with silanol or silyl group, for example.

According to such a configuration, the dispersibility of the insulating fine particles in the dispersion improves, when the dispersion of the insulating fine particles is applied to form the insulating fine particle layer. Accordingly, aggregation in the dispersion is inhibited, and a more uniform insulating fine particle layer can be formed.

In an embodiment of the present invention, in addition to the above-described configuration of the present invention, the second electrode may be formed of at least one metal of gold, silver, tungsten, titanium, aluminum and palladium. Having a lower work function, these substances provide an electron emitting element that allows electrons having passed through the insulating fine particle layer to tunnel efficiently to emit more high-energy electrons from the second electrode.

Further, use of an electron emitting element of the present invention in an air blowing device or a cooling device enables high-efficiency cooling without experiencing electric discharge and generation of harmful substances such as ozone and NOx by utilizing slip effect on a surface of an object being cooled.

Further, use of an electron emitting element of the present invention in a charging device and an image forming apparatus including the charging device enables stable charging of an object for a longer time without experiencing electric discharge and generation of harmful substances such as ozone and NOx.

In addition, an electron emitting element of the present invention may be used in an electron emitting device. That is, the present invention may be an electron emitting device comprising any one of the above-described electron emitting elements and a power supply for applying a voltage between the first electrode and the second electrode. For example, the electron emitting device may include a power supply for applying a direct-current voltage or an alternating current voltage between the first electrode and the second electrode. The present invention can provide an electron emitting element that can emit sufficient electrons and that is less prone to dielectric breakdown.

These devices, that is, the air blowing device, the cooling device, the charging device, the image forming apparatus and the electron emitting device may include a plurality of electron emitting elements. For example, a plurality of electron emitting elements may be arranged on a planar body to be applied to these devices. In addition, a plurality of electron emitting elements may share a first electrode to be applied to these devices.

According to another aspect of the present invention, there is provided a method for producing an electron emitting element, the electron emitting element comprising: a first electrode; an insulating fine particle layer formed on the first electrode; and a second electrode formed on the insulating fine particle layer, the insulating fine particle layer composed of first insulating fine particles and second insulating fine particles larger than the first insulating fine particles, a surface of the insulating fine particle layer having a projection formed from the second insulating fine particles, wherein when a voltage is applied between the first electrode and the second electrode, electrons provided from the first electrode are accelerated in the insulating fine particle layer to be emitted from the second electrode via the projection, the method comprising the steps of: forming the insulating fine particle layer composed of the first and second insulating fine particles on the first electrode; and forming the second electrode on the insulating fine particle layer and opposite the first electrode, wherein the step of forming the insulating fine particle layer is a step of applying a dispersion of the first and second insulating fine particles onto the first electrode.

The present invention can provide a method for producing an electron emitting element that can emit sufficient electrons and that is less prone to dielectric breakdown.

In an embodiment of the present invention, the first and second insulating fine particles in the step of forming the insulating fine particle layer may be surface-treated insulating fine particles. In this case, aggregation in the dispersion is inhibited and an electron emitting element including a more uniform insulating fine particle layer can be produced.

Hereinafter, embodiments and examples of the present invention will be described in detail with reference to FIG. 1 to FIG. 6. It should be noted that the following embodiments and examples are merely concrete examples of the present invention and the present invention is not limited to the following embodiments and examples.

### Embodiment 1

FIG. 1 is a schematic view illustrating a configuration according to an embodiment of the electron emitting element of the present invention. As illustrated in FIG. 1, an electron emitting element 10 of the present embodiment comprises: an electrode substrate 1; and an electron acceleration layer 4 formed on the electrode substrate 1 and composed of insulating fine particles.

The electrode substrate 1 is an electrode also serving as a substrate and composed of a plate-like material formed from a conductor. Specifically, it is composed of a plate-like material formed from a stainless used steel (SUS). Functioning as an electrode as well as a support of the electron emitting element, the electrode substrate 1 preferably has a certain level of mechanical strength and appropriate conductivity. Other than the stainless used steel (SUS), for example, a substrate formed from a metal such as SUS, Ti and Cu; and a substrates of a semiconductor such as Si, Ge and GaAs may be used.

Alternatively, the electrode substrate 1 may be a structure obtained by forming an electrode made of a metal film on an insulating substrate such as a glass substrate or a plastic substrate. When an insulating substrate such as a glass substrate is used, for example, an insulating substrate whose surface being the interface with the electron acceleration layer 4 is coated with a conductive material such as a metal may be used as the electrode substrate 1. Any kind of conductive material may be used for the electrode, as long as magnetron sputtering can be used for the conductive material. When stable operation in the atmosphere is desired, however, conductive materials having higher antioxydation power are preferably used, and noble metals are more preferably used.

ITO is also useful for the conductive material as being an electrically conductive oxide material which is widely used for a transparent electrode. Further, a plurality of conductive materials may be used to coat the insulating substrate in order to form a tough thin film. For example, a metallic thin film obtained by forming a Ti film having a thickness of 200 nm and further forming a Cu film having a thickness of 1000 nm on a surface of a glass substrate may be used as the electrode substrate 1. By coating a glass substrate with such a Ti thin film and a Cu thin film, a tough thin film can be formed.

When a surface of the insulating substrate is coated with a conductive material, a pattern in a rectangle shape or the like may be formed by well-known photolithography or masking to form an electrode. While the conductive material and the thickness of the thin film are not particularly limited, the electrode substrate 1 should have good adhesiveness with structures including the electron acceleration layer to be formed thereon as described below.

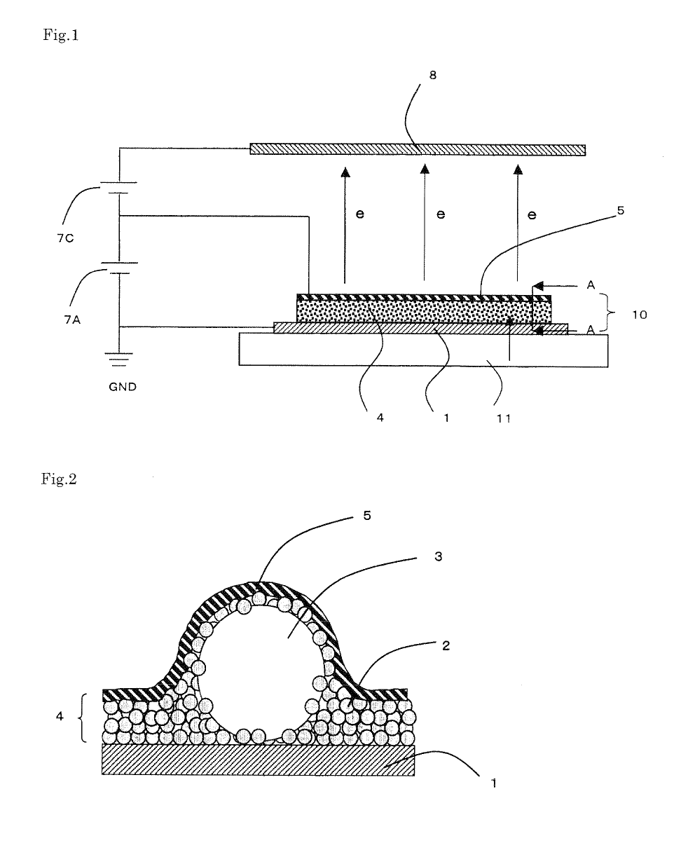

The electron acceleration layer 4 is formed on the electrode substrate 1 as a layer covering the electrode partially or entirely and composed of insulating fine particles. The insulating fine particles consist of two kinds of insulating fine particles. FIG. 2 is a sectional view taken along a line A-A in FIG. 1 to show an enlarged view of a cross section around the electron acceleration layer 4 out of the configuration according to an embodiment of the electron emitting element of the present invention.

As illustrated in FIG. 2, the electron acceleration layer 4 is composed of A insulating fine particles 2 and B insulating fine particles 3 larger than the A insulating fine particles 2, and has projections 6 formed from the B insulating fine particles 3 on a surface facing a thin-film electrode 5.

The A insulating fine particles 2 are insulating particles having an average particle diameter of 10 nm. The average particle diameter of the A insulating fine particles 2 is not limited as long as it is smaller than the average particle diameter of the B insulating fine particles 3 to be described later, and it is preferably 7 nm to 400 nm. When the average particle diameter is 7 nm or more, the insulating fine particles are easily dispersed in a dispersion thereof to form the layer 4. When the average particle diameter is 400 nm or less, it is easy to form the electron acceleration layer 4 having an appropriate thickness. The average particle diameter is therefore preferably in the above-specified range. In addition, the average particle diameter in the above-specified range allows easy formation of a film having an appropriate thickness and prevents volatilization of a solvent of the dispersion from being difficult when the electron acceleration layer 4 is formed with the dispersion.

In addition, while the A insulating fine particles 2 have an average particle diameter within the above-specified range, the variation of the A insulating fine particles 2, that is, the distribution of their particle diameters may be broad relative to the average particle diameter. For example, fine particles having an average particle diameter of 50 nm may have the particle diameter distribution in a range of 20 nm to 100 nm. The electron acceleration layer 4 in the present embodiment has the projections 6 derived from the B insulating fine particles 3. Then, the distribution of the particle diameters of the A insulating fine particles 2 is preferably small relative to the average particle diameter of the B insulating fine particles 3 and broad relative to the distribution of the particle diameters of the B insulating fine particles 3 so that the projections 6 will be larger than the A insulating fine particles 2.

Practically, the A insulating fine particles 2 are formed from an insulator such as SiO₂, Al₂O₃ and TiO₂, but they may be formed from a metal oxide or a metal nitride. For example, silica particles may be used. The A insulating fine particles 2 may be formed from fine particles of an organic polymer. Examples of the fine particles of an organic polymer include highly cross-linked polymer fine particles of styrene/divinylbenzene (SX8743) manufactured and sold by JSR Corporation, and silicone resin fine particles, Tospearl, manufactured by a limited liability company of Momentive Performance Materials Inc.

The B insulating fine particles 3 are insulating particles having an average particle diameter of 1 μm. The average particle diameter of the B insulating fine particles 3 is not limited as long as it is larger than the average particle diameter of the A insulating fine particles 2, and it is preferably 1 μm to 9 μm. The electron acceleration layer 4 in the present embodiment has the projections 6 formed from the B insulating fine particles 3. Then, the B insulating fine particles 3 may be selected so that the projections 6 will be larger than the A insulating fine particles 2. For example, when the projections 6 formed from the B insulating fine particles (parts formed from the B insulating fine particles 3 in the electron acceleration layer 4) is sufficiently larger than the part formed from the A insulating fine particles 2 in the electron acceleration layer 4 as illustrated in FIG. 2, the average particle diameter of the B insulating fine particles 3 is preferably 9 or more times the average particle diameter of the A insulating fine particles 2. In a specific example where the average particle diameter of the A insulating fine particles 2 is 110 nm, the B insulating fine particles 3 having an average particle diameter of 1 μm, which is approximately 9 times the average particle diameter of the A insulating fine particles 2, are preferably used. In another specific example where the average particle diameter of the A insulating fine particles 2 is 10 nm, the B insulating fine particles 3 having an average particle diameter of 8.6 μm, which is approximately 860 times the average particle diameter of the A insulating fine particles 2, are preferably used. As described above, the B insulating fine particles 3 preferably have an average particle diameter differing from the average particle diameter of the A insulating fine particles 2 by digits (for example, 10 times or 100 times the average particle diameter of the A insulating fine particles 2).

The variation of the B insulating fine particles 3, that is, the distribution of their particle diameters is preferably sharp relative to their average particle diameter. Since the B insulating fine particles 3 have a particle diameter relatively large compared with the A insulating fine particles 2 and form the projections on the surface of the electron acceleration layer 4, it is preferable that the distribution of the particle diameters thereof is relatively sharp compared with the distribution of the particle diameters of the A insulating fine particles 2.

As in the case of the A insulating fine particles 2, the B insulating fine particles 3 may be formed from an insulator such as SiO₂, Al₂O₃ and TiO₂, or may be formed from a metal oxide or a metal nitride. Alternatively, the B insulating fine particles 3 may be formed from fine particles of an organic polymer. As in the case of the A insulating fine particles 2, silica particles, highly cross-linked polymer fine particles of styrene/divinylbenzene and silicone resin fine particles may be used.

In addition, the B insulating fine particles 3 may be formed from an insulating material different from the material of the A insulating fine particles 2; the B insulating fine particles 3 do not necessarily have the same composition as the A insulating fine particles 2. For example, alumina fine particles may be used for the B insulating fine particles 3 and silica fine particles may be used for the A insulating fine particles 2.

The A insulating fine particles 2 and the B insulating fine particles 3 may be surface-treated fine particles. The surface treatment may be with silanol or silyl group. In the formation of the electron acceleration layer 4, the A insulating fine particles 2 and the B insulating fine particles 3 are dispersed in a solvent and applied to the electrode substrate 1. Being surface-treated with silanol or silyl group, the particles are improved in the dispersibility in the solvent to easily form the electron acceleration layer 4 having the A insulating fine particles 2 and the B insulating fine particles 3 uniformly dispersed. As a result of the uniform dispersion of the A insulating fine particles 2 and the B insulating fine particles 3, the electron acceleration layer 4 can be formed to have a small thickness (particularly in the part formed from the A insulating fine particles 2) and high surface smoothness. Accordingly, the thin-film electrode on the electron acceleration layer 4 can be formed thin.

The surface treatment with silanol or silyl group includes a dry process and a wet process, and either process may be used.

In the dry process, for example, a silane compound or a dilute aqueous solution thereof is added dropwise or sprayed with a spray to insulating fine particles under stirring in a stirrer, and then dried by heating. The desired surface-treated insulating fine particles can be thereby obtained.

In the wet process, for example, a solvent is added to insulating fine particles to form a sol, and then a silane compound or a dilute aqueous solution thereof is added to the sol to perform surface treatment. Subsequently, the solvent is removed from the sol of the surface-treated fine particles, followed by drying and sieving. The desired surface-treated insulating fine particles can be thereby obtained. Further surface treatment may be performed on the thus surface-treated insulating fine particles.

As the silane compound, may be used compounds represented by the chemical structural formula: RaSiX4-a, wherein a represents an integer from 0 to 3, R represents a hydrogen atom or an organic group such as alkyl group and alkenyl group, X represents a chlorine atom or a hydrolyzable group such as methoxy group and ethoxy group; any type of chlorosilane, alkoxysilane, silazane and special sililating agents may be used.

Representative and specific examples of the silane compound include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-bis(trimethylsilyl)acetamide, N,N-bis(trimethylsilyl)urea, tert-butyldimethylchlorosilane, vinyltrichlorosilane, vinyltrimethoxysilane, vinyltriethoxysilane, γ-methacryloxypropyl trimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethox ysilane and γ-chloropropyltrimethoxysilane. Out of them, in particular, dimethyldimethoxysilane, hexamethyldisilazane, methyltrimethoxysilane and dimethyldichlorosilane are preferable.

Other than the above-mentioned silane compounds, silicone oils such as dimethyl silicone oil and methyl hydrogen silicone oil may be used.

The projections 6 are formed from the A insulating fine particles 2 and the B insulating fine particles 3, that is, the A insulating fine particles 2 form a layer and the B insulating fine particles 3 reside in the layer to form the projections 6. Specifically, the B insulating fine particles 3 each substantially take up the electron acceleration layer 4 in each of the parts formed from the A insulating fine particle 2 and the B insulating fine particles 3 to form the projections 6. For example, the B insulating fine particles 3 form the projections 6 by having a diameter larger than the layer thickness of the other part formed from the A insulating fine particles 2 in the electron acceleration layer 4 (the A insulating fine particles 2 may attach to the B insulating fine particles 3 to bury the B insulating fine particles 3 in the electron acceleration layer 4). In the embodiment illustrated in FIG. 2, the B insulating fine particles 3 have a particle diameter (average particle diameter) larger than the part of the layer formed from the A insulating fine particles 2 (the part of the layer formed from the A insulating fine particles 2 has a thickness half of the particle diameter of the B insulating fine particles 3) thereby to form hemispherically-shaped projections 6.

When the B insulating fine particles 3 form the hemispherically-shaped projections 6, for example, the projections 6 have a height of 0.5 μm to 4.5 μm (half of the average particle diameter). Such projections 6 can be formed by using the B insulating fine particles 3 having an average particle diameter larger than the layer thickness of the part formed from the A insulating fine particles 2 in the electron acceleration layer 4.

As described below in Examples, the projections 6 may be formed by using the B insulating fine particles 3 having a size of 1 micron to 9 microns so as to have a width of 1 μm to 30 μm, for example.

Hereinafter, the effect of the projections 6 will be described along with a mechanism of the electron emitting element.

The mechanism of the electron emitting element of the present embodiment for emitting electrons is similar to the mechanism of the MIM type electron emitting element described in the Description of the Related Art. It has been generally explained that in the mechanism of the MIM type electron emitting element, emission of electrons is attributed to a) diffusion of an electrode material into an insulating layer, b) crystallization of an insulating material, c) formation of a conductive pathway called filament, d) a nonstoichiometric insulating material or e) electron trap due to a defect of an insulating material and a locally intense electric field area formed by the trapped electrons. While there are various theories to explain the MIM type electron emitting element, it is reasonable to assume that the mechanism of the electron emitting element of the present embodiment work in the same manner as the mechanism of the MIM type electron emitting element, because the electron acceleration layer 4 is composed of an insulator. In the electron emitting element of the present embodiment, in any theory, it is considered that a current path is formed when an electric field is applied to the electron acceleration layer, which corresponds to the insulating layer, composed of insulating fine particles, and some electrons in the current are accelerated by the electric field between the two electrodes to be ballistic electrons to go through the electrode substrate to the thin-film electrode and be emitted to the outside of the element.

According to e) of the five factors a) to e) described above regarding the formation of the conductive pathway, the electron emitting element of the present embodiment can be described as follows. The electron emitting element comprises the electrode substrate, the electron acceleration layer and the thin-film electrode. When a voltage is applied between the electrode substrate and the thin-film electrode, electrons move from the electrode substrate to surfaces of the A and B insulating fine particles (first and second insulating fine particles) in the electron acceleration layer (insulating fine particle layer) provided between the electrode substrate and the thin-film electrode. Since the resistance inside of the insulating fine particles is high, the electrons are conducted through the surfaces of the A and B insulating fine particles. Since the B insulating fine particles are larger than the A insulating fine particles, the electrons are conducted mainly through the surfaces of the B insulating fine particles. On this occasion, the electrons are trapped at impurities on the surfaces of the insulating fine particles, oxygen defect that may be caused when the insulating fine particles are an oxide or points of contact among the insulating fine particles. The trapped electrons work as fixed charges. As a result, on the surfaces of the A and B insulating fine particles, the applied voltage together with an electric field formed by the trapped electrons form an intense electric field, and the electrons are accelerated by the intense electric field to be emitted from the thin-film electrode.

Meanwhile, since the surface of the insulating fine particle layer has the projections derived from the B insulating fine particles, the electrons conducted through the surfaces of the B insulating fine particles are accelerated toward the projections. The electrons are then emitted from the thin-film electrode on the projections.

Thus, it is considered that the projections 6 are deeply involved in the effect of the electron emitting element of the present embodiment.

Since the projections 6 function according to the mechanism described above to contribute to the electron emission, the shape thereof is not limited to hemisphere. For example, it may be ellipsoidally-shaped, or rod-shaped insulating fine particles may be used as the B insulating fine particles 3 to form the projections 6. In addition, a small amount of the A insulating fine particles 2 may attach to the B insulating fine particles 3 to form the projections 6, for example, as long as the projections 6 are formed mainly from the B insulating fine particles 3. Furthermore, at least one projection 6 is formed on the electron acceleration layer 4.

As illustrated in FIG. 2, the electron acceleration layer 4 consists of the part formed from the A insulating fine particles 2, and the parts formed substantially from the B insulating fine particles 3, and the part formed from the A insulating fine particles 2 consists only of the A insulating fine particles 2. On the other hand, the parts formed substantially from the B insulating fine particles 3 include the A insulating fine particles 2 and the B insulating fine particles 3, that is, the B insulating fine particles 3 take up most of the layer thickness of the parts to substantially form the parts (when the B insulating fine particles 3 are sufficiently larger than the A insulating fine particles 2, the A insulating fine particles 2 hardly affect the layer thickness of the parts formed from the B insulating fine particles 3.) Each of the parts formed from the B insulating fine particles 3 includes one particle of the B insulating fine particles 3, and the projections 6 are formed from the B insulating fine particles 3.

The part formed from the A insulating fine particles 2 in the electron acceleration layer 4 exclusively includes the A insulating fine particles 2 and preferably has a layer thickness of 2 μm or less. When the part formed from the A insulating fine particles 2 in the electron acceleration layer 4 has a layer thickness of more than 2 μm, the electric resistance of the electron acceleration layer 4 will be so large to prevent sufficient current flow even with the projections derived from the B insulating fine particles 3, and therefore sufficient electrons cannot be emitted. Accordingly, the part formed from the A insulating fine particles 2 in the electron acceleration layer 4 preferably has a layer thickness of 2 μm or less.

While the smaller the layer thickness of the electron acceleration layer 4, the higher the flowability of the current, the layer thickness will be the smallest when the insulating fine particles in the electron acceleration layer 4 do not overlap each other, covering the electrode substrate uniformly. That is to say, the part formed from the A insulating fine particles in the electron acceleration layer 4 preferably has a layer thickness equal to or larger than the average particle diameter of the A insulating fine particles forming the layer. When the part formed from the A insulating fine particles in the electron acceleration layer has a layer thickness smaller than the average particle diameter of the A insulating fine particles, the electron acceleration layer 4 will have a part having no A insulating fine particle 2, and such a layer will not function as an electron acceleration layer. On the other hand, when the electron acceleration layer 4 has a thickness corresponding to one insulating fine particle, the amount of the current flowing through the electron acceleration layer 4 increases but the leakage current also increases. As a result, an electric field being applied to the electron acceleration layer 4 will be so weak that efficient electron emission cannot be performed. Accordingly, the part formed from the A insulating fine particles 2 in the electron acceleration layer 4 preferably has a layer thickness in which two or three particles of the insulating fine particles are stacked.

However, the layer thicknesses of more than 2 μm leads to increase in the electric resistance of the electron acceleration layer 4 to decrease the flowability of the current in the electron acceleration layer 4 as described above even when two or three particles of the insulating fine particles are stacked to constitute the layer thickness. Accordingly, the part formed from the A insulating fine particles 2 in the electron acceleration layer 4 preferably has a layer thickness in which two or three particles of the insulating fine particles are stacked and which does not exceed 2 μm.

As illustrated in FIG. 1, the electron emitting element 10 of the present embodiment comprises: the electrode substrate 1; the electron acceleration layer 4; and the thin-film electrode 5 formed on the electron acceleration layer 4 and opposite the electrode substrate 1. When a voltage is applied between the electrode substrate 1 and the thin-film electrode 5, the electron emitting element 10 accelerates electrons provided from the electrode substrate 1 on the electron acceleration layer 4 to emit them from the thin-film electrode 5.

The thin-film electrode 5 is formed on the electron acceleration layer 4 and opposite the electrode substrate 1. The thin-film electrode 5 is an electrode that forms a pair with the electrode substrate 1 and that, together with the electrode substrate 1, is used for applying a voltage to the inside of the electron acceleration layer 4. Accordingly, the material thereof should have conductivity to the extent that it can function as an electrode. In particular, a material which has a low work function and from which a thin-film can be formed is expected to provide a greater effect, because the thin-film electrode 5 is also an electrode that transmits and emits, with a minimum energy loss, electrons caused to have higher energy due to the acceleration within the electron acceleration layer 4. Examples of such a material include: gold, silver, tungsten, titanium, aluminum and palladium each of which has a work function in a range of 4 eV to 5 eV. In particular, in consideration of operation under an atmospheric pressure, gold is the best material, which is free from oxide or sulfide formation reaction. Further, silver, palladium and tungsten, each of which has a relatively small oxide formation reaction, are also applicable materials that can be used without any problem.

In addition, the thin-film electrode 5 is formed on the electron acceleration layer 4 to have a film thickness that covers the projections 6 formed from the B insulating fine particles 3 as illustrated in FIG. 2. The film thickness of the thin-film electrode 5 is important as a condition for efficiently emitting electrons from the electron emitting element 10 to the outside of the element in addition to the function of covering the projections 6. In this view, the film thickness of the thin-film electrode 5 is preferably in a range of 10 nm to 55 nm, though a general electrode is preferably has a thickness as small as possible to allow more efficient electron emission as long as the thickness is to ensure electrical conduction. The minimum film thickness for the thin-film electrode 5 to function as an electrode is 10 nm, and the film thickness of 10 nm or more can ensure electrical conduction. On the other hand, the maximum film thickness for the thin-film electrode 5 to allow electrons to be emitted from the electron emitting element 10 to the outside is 55 nm. When the film thickness is 55 nm or less, ballistic electrons pass thorough the thin-film electrode 5, and the ballistic electrons are less likely to be recaptured in the electron acceleration layer 4 by being absorbed by or reflected back on the thin-film electrode 5.

In use of the electron emitting element of the present embodiment, the electrode substrate 1 and the thin-film electrode 5 are connected to a power supply 7. As illustrated in FIG. 1, an electron emitting device may be formed to include the electron emitting element 10, and the power supply 7 connected to the electrode substrate 1 and the thin-film electrode 5. This power supply may be a direct-current power supply or an alternating current power supply.

### Production Method

Next, a method for producing the electron emitting element 10 according to Embodiment 1 will be described.

First, the B insulating fine particles are dispersed in a solvent to prepare a dispersion (dispersion step 1). The solvent usable here is not particularly limited as long as it allows the B insulating fine particles to be dispersed therein and can be dried after coating. Example thereof include toluene, benzene, xylene, hexane, methanol, ethanol and propanol. As described above, alumina particles or silica particles are used for the B insulating fine particles, for example. For example, the B insulating fine particles are dispersed in the solvent at a concentration of 0.3 wt %. In the dispersion step, an ultrasonic disperser may be used in order to sufficiently disperse the B insulating fine particles in the solvent.

Subsequently, the A insulating fine particles are dispersed in the dispersion prepared (dispersion step 2). As described above, silica particles are used for the A insulating fine particles, for example. The A insulating fine particles in an amount to give a desired concentration are mixed with and dispersed in the above-described dispersion. For example, the A insulating fine particles are dispersed at a concentration of 8.0 wt % relative to the dispersion. An ultrasonic disperser is suitably used also for dispersing the A insulating fine particles.

In the present embodiment, the dispersion step 1 in which the fine particles having a larger particle diameter are dispersed in the solvent is performed before the dispersion step 2, but the dispersion step 1 may be performed after the dispersion step 2.

Subsequently, the dispersion prepared by dispersing the A insulating fine particles and the B insulating fine particles is applied by a spin coating method to coat the electrode substrate 1 (coating step), and then the applied dispersion is dried to form the electron acceleration layer 4 (electron acceleration layer formation step). A predetermined film thickness can be obtained by repeating the film formation by the spin coating method and the drying (drying step) several times. Other than the spin coating method, the electron acceleration layer 4 can be formed by, for example, a dropping method or a spray coating method.

Subsequently, after the formation of the electron acceleration layer 4, the thin-film electrode 5 is formed on the electron acceleration layer 4 (thin-film electrode formation step). For forming the thin-film electrode 5, a magnetron sputtering method may be used, for example. Alternatively, the thin-film electrode 5 may be formed by an inkjet method, a spin coating method or a vapor deposition method, for example.

### EXAMPLES

In the following examples, will be described an experiment to measure the electron emitting element of Embodiment 1 for the current. This experiment is merely an example of embodiments and by no means limits the present invention.

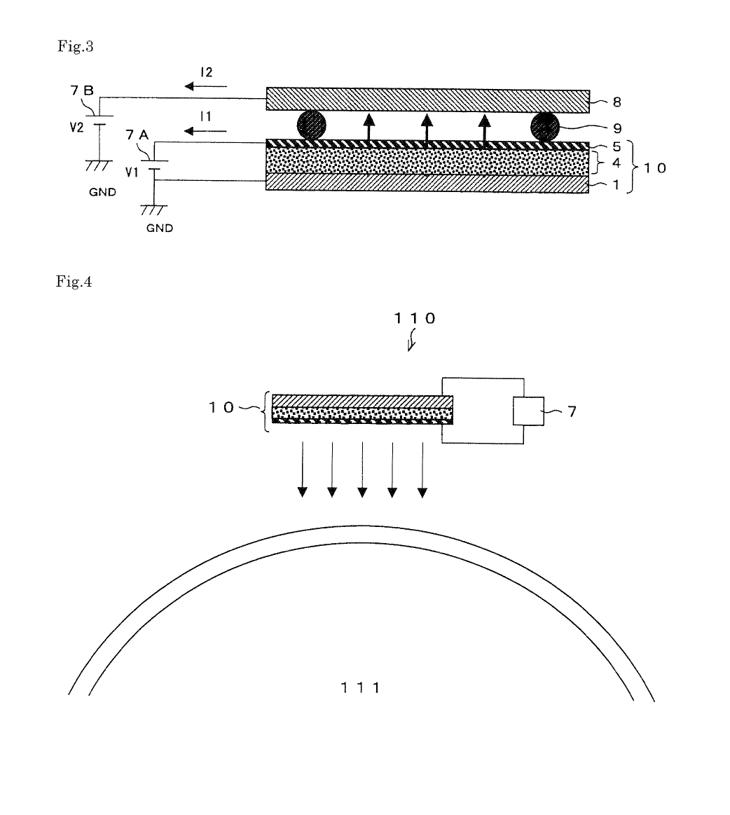

First, electron emitting elements of Examples 1 and 2, electron emitting elements of Comparative Examples 1 and 2 were produced as described below. Then, the electron emitting elements of Examples 1 and 2, and the electron emitting elements of Comparative Examples 1 and 2 were measured for the electron emission current per unit area by using an experiment system illustrated in FIG. 3. In the experiment system in FIG. 3, a counter electrode 8 was disposed on a side of the thin-film electrode 5 of the electron emitting element 10 so that the counter electrode 8 and the thin-film electrode 5 had an insulating spacer 9 therebetween. The electron emitting element 10 and the counter electrode 8 were connected to the power supplies 7, respectively so that a voltage V1 was applied to the electron emitting element 10 and a voltage V2 was applied to the counter electrode 8. The above-described experiment system was set up in vacuum, and the V1 was increased stepwise to perform the electron emission experiment. The distance between the electron emitting element and the counter electrode, having the insulating spacer 9 therebetween, was 5 mm in the experiment. The voltage V2 applied to the counter electrode was 100 V.

### Example 1

To a reagent bottle, 3 mL of ethanol as a solvent was put in, and then 0.01 g of alumina fine particles 1.0CR (BAIKALOX 1.0CR, product by Baikowski, nominal average particle diameter: 1.0 μm according to the manufacturer) were put in. Subsequently, the reagent bottle was applied to an ultrasonic disperser to prepare a dispersion of alumina particles. To the dispersion of alumina particles, 0.25 g of silica particles (average particle diameter: 110 nm, specific surface area: 30 m²/g) surface-treated with hexamethyldisilazane (HMDS) was added, and the reagent bottle was applied to the ultrasonic disperser to prepare a dispersion of insulating fine particles.

Next, a 24 mm square SUS substrate was prepared as the electrode substrate 1, and the dispersion of insulating fine particles was applied onto the SUS substrate dropwise to form an electron acceleration layer by a spin coating method. The film formation by the spin coating method was performed under a condition of spinning at 500 rpm for 5 seconds and then spinning at 3000 rpm for 10 seconds after the dispersion of insulating fine particles was applied to a surface of the SUS substrate dropwise. Two layers of the fine particle layers were deposited on the SUS substrate by repeating the film formation under the above-described condition twice and left to naturally dry at room temperature.

Then, the thin-film electrode 5 was formed on a surface of the electron acceleration layer with a magnetron sputtering apparatus to obtain the electron emitting element of Example 1. Gold was used as the material of the film formed, the thickness of the thin-film electrode 5 was 40 nm, and the area of the thin-film electrode 5 was 0.01 cm².

The electron emitting element was measured for the electron emission current in vacuum at 1×10⁻⁸ ATM to show an electron emission current of 0.3 mA/cm² when the voltage V1 applied to the thin-film electrode 5 was 18 V.

The electron emitting element produced was observed with a scanning electron microscope (SEM) to confirm that projections formed from the alumina fine particles exist on the electron acceleration layer. The width of the projections ranged from 1 μm to 5 μm to confirm in terms of the size that the projections are formed from the alumina fine particles.

### Example 2

To a reagent bottle, 2.5 mL of toluene as a solvent was put in, and then 0.003 g of silica particles (average particle diameter: 8.6 μm, specific surface area: 0.8 m²/g) surface-treated with hexamethyldisilazane (HMDS) were put in. Subsequently, the reagent bottle was applied to an ultrasonic disperser to prepare a dispersion of silica particles. To the dispersion of silica particles, 0.36 g of high-purity organosol PL-1-TOL (product by Fuso Chemical Co., Ltd., nominal particle diameter: 10 nm to 15 nm according to the manufacturer, dispersed in toluene, solid concentration: 40%) was added and stirred to prepare a dispersion of insulating fine particles of Example 2. This dispersion of insulating fine particles was used to produce the electron emitting element of Example 2 in the same manner as in Example 1.

The electron emitting element was measured for the electron emission current in vacuum at 1×10⁻⁸ ATM to show an electron emission current of 5.0×10⁻² mA/cm² when the voltage V1 applied to the thin-film electrode 5 was 17 V.

The electron emitting element produced in Example 2 was also observed with an optical microscope to confirm that projections formed from the silica particles (average particle diameter: 8.6 μm) exist on the electron acceleration layer. As in the case of Example 1, the width of the projections ranged from 10 μm to 30 μm to confirm in terms of the size that the projections are formed from the silica particles.

### Comparative Example 1

To a reagent bottle, 3 mL of ethanol as a solvent was put in, and then 0.25 g of silica particles (average particle diameter: 110 nm, specific surface area: 30 m²/g) surface-treated with hexamethyldisilazane (HMDS) were put in. Subsequently, the reagent bottle was applied to an ultrasonic disperser to prepare a dispersion of insulating fine particles. This dispersion of insulating fine particles was used to produce the electron emitting element of Comparative Example 1 in the same manner as in Example 1.

This electron emitting element was measured for the electron emission current in vacuum at 1×10⁻⁸ ATM to show an electron emission current of 0.1 mA/cm² when the voltage V1 applied to the thin-film electrode 5 was 25 V.

### Comparative Example 2

To a reagent bottle, 0.33 g of high-purity organosol PL-1-TOL (product by Fuso Chemical Co., Ltd., nominal particle diameter: 10 nm to 15 nm according to the manufacturer, dispersed in toluene, solid concentration: 40%) was put in, and then 2.0 mL of toluene was added thereto little by little and stirred to prepare a dispersion of insulating fine particles.

This dispersion of insulating fine particles was used to produce the electron emitting element of Comparative Example 2 in the same manner as in Example 1.

The electron emitting element was measured for the electron emission current in vacuum at 1×10⁻⁸ ATM to show an electron emission current of 1.5×10⁻³ mA/cm² when the voltage V1 applied to the thin-film electrode 5 was 16 V.

These Examples and Comparative Examples have revealed that the configuration including the A insulating fine particles and the B insulating fine particles larger than the A insulating fine particles and having at least one projection derived from the B insulating fine particles allows stable electron emission in a satisfactory amount.

### Embodiment 2

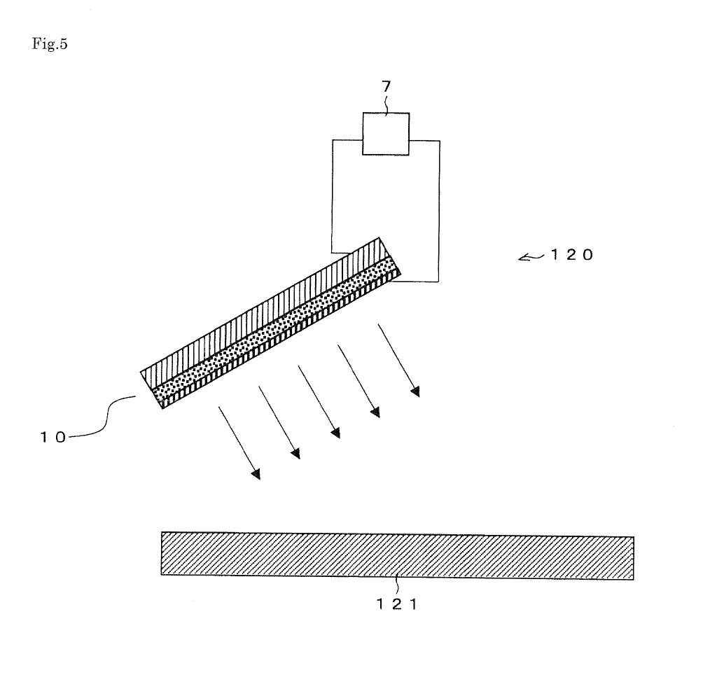

FIG. 4 illustrates an example of a charging device 110 including the electron emitting element 10 of Embodiment 1. The charging device 110 comprises an electron emitting device 100 having the electron emitting element 10 and the power supply 7 for applying a voltage to the electron emitting element 10. The charging device 110 is used for electrically charging a photoreceptor 111. An image forming apparatus of the present embodiment includes the charging device 110. In the image forming apparatus of the present embodiment, the electron emitting element 10 constituting the charging device 110 is disposed so as to face the photoreceptor 111 being charged. Application of a voltage causes emission of electrons so that the photoreceptor 111 is electrically charged. In the image forming apparatus of the present embodiment, other than the charging device 110, conventionally known constituents may be used. The electron emitting element 10 serving as the charging device 110 is preferably provided so as to be, for example, 3 mm to 5 mm apart from the photoreceptor 111. Further, it is preferable that a voltage of approximately 25 V is applied to the electron emitting element 10. The electron acceleration layer of the electron emitting element 10 is preferably configured such that 1 μA/cm² of electrons are emitted per unit time in response to application of a voltage of 25 V, for example.

The electron emitting element 10 serving as the charging device 110 operates without electric discharge, and therefore the charging device 110 generates no ozone. Ozone is harmful to human bodies, and therefore regulated in various environmental standards. Even if ozone is not discharged to the outside of the apparatus, ozone oxidizes and deteriorates an organic material such as the photoreceptor 111 and a belt in the apparatus. Such a problem can be solved by using the electron emitting element 10 of the present embodiment for the charging device 110 and further including such a charging device 110 in the image forming apparatus. In addition, since the electron emitting element 10 is improved in the electron emission efficiency, the charging device 110 can perform the charging efficiently.

Further, the electron emitting element 10 serving as the charging device 110 is configured as a planar electron source including a plate-like electrode substrate 1 and therefore capable of charging the photoreceptor 111 on an area that has a width in a rotation direction. This provides many chances for charging a section of the photoreceptor 111. Therefore, the charging device 110 can perform more uniform electric charging as compared to a wire charging device, which performs electric charging line by line. Further, the charging device 110 has an advantage such that the voltage being applied is approximately 10 V, which is far lower than that of a corona discharge device, which requires a voltage of several kV be applied.

### Embodiment 3

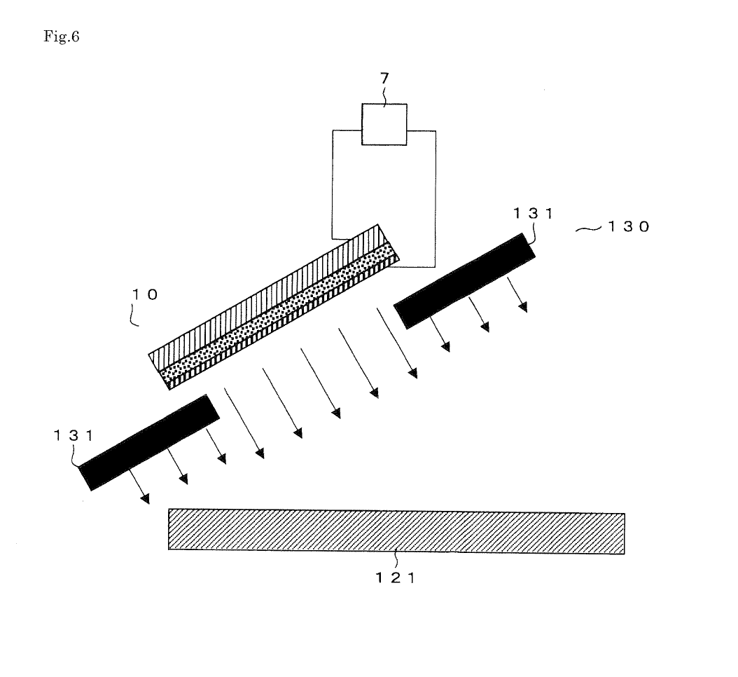

FIGS. 5 and 6 each illustrate an example of an air blowing device including the electron emitting element 10 of Embodiment 1. The following description will be on the assumption that the air blowing device is used as a cooling device, for example.

An air blowing device 120 illustrated in FIG. 5 comprises an electron emitting device 100 having the electron emitting element 10 and the power supply 7 for applying a voltage to the electron emitting element 10. In the air blowing device 120, the electron emitting element 10 emits electrons toward an object 121 to be cooled so that ion wind is generated and the object 121 electrically grounded is cooled. When the object 121 is cooled, it is preferable that a voltage of approximately 18 V is applied to the electron emitting element 10 and the electron emitting element 10 emits, for example, 1 μA/cm² of electrons per unit time in the atmosphere at the voltage.

In addition to the configuration of the air blowing device 120 illustrated in FIG. 5, an air blowing device 130 illustrated in FIG. 6 includes a blowing fan 131. In the air blowing device 130 illustrated in FIG. 6, the electron emitting element 10 emits electrons toward the object 121 to be cooled, and the blowing fan 131 blows air toward the object 121 to send the electrons emitted from the electron emitting element 10 toward the object 121 and generate ion wind so that the object 121 electrically grounded is cooled. In this case, it is preferable that an air volume generated by the blowing fan 131 is in a range of 0.9 L to 2 L per minute per square centimeter.

When the object 121 is cooled only by air blown by a fan or the like as in the case of a conventional air blowing device or a conventional cooling device, the flow rate on a surface of the object 121 will be 0 and the air in a section from which heat is dissipated most desirably is not replaced, leading to low cooling efficiency. However, when electrically charged particles such as electrons or ions are included in the air blown, the air blown is attracted to the surface of the object 121 by electric force when in the vicinity of the object 121 to allow the air in the vicinity of the surface of the object 121 to be replaced. Here, since the air blowing devices 120, 130 of the present invention blow air including electrically charged particles such as electrons or ions, the cooling efficiency is significantly improved. Furthermore, since the electron emitting element 10 is improved in the electron emission efficiency, the air blowing devices 120, 130 can perform the cooling more efficiently. The air blowing devices 120, 130 are expected to operate in the atmosphere.

The electron emitting element 10 described in Embodiment 1 may be used for a light emitting device, an image display device, an electron-beam curing device as well as an air blowing device, a cooling device, a charging device, an image forming apparatus and an electron emitting device. It is possible to provide a light emitting device that is stable, long-life and capable of performing planar light emission by using the electron emitting element of Embodiment 1 in the light emitting device or an image display device including the light emitting device. Further, use of the electron emitting element of Embodiment 1 in an electron-beam curing device enables area-by-area electron-beam curing and achievement of a maskless process, thereby achieving low cost and high throughput.

The present invention is not limited to the embodiments and the examples described above, and various other changes may be made within the scope of the invention as defined by the appended claims. That is, other embodiments obtained by combining technical means appropriately changed within the scope of the present invention as defined by the appended claims are also included in the technical scope of the present invention.

### INDUSTRIAL APPLICABILITY

The electron emitting element of the present invention emits sufficient electrons and is less prone to any dielectric breakdown. Accordingly, the electron emitting element of the present invention can be suitably applied to, for example, a charging device of an image forming apparatus such as an electrophotographic copying machine, a printer and a facsimile; an electron-beam curing device; an image display device when in combination with a luminous body; and a cooling device when utilizing ion wind generated by electrons emitted therefrom.

What is claimed is:

1. An electron emitting element, comprising:
a first electrode;
an insulating fine particle layer formed on the first electrode and comprising first insulating fine particles and second insulating fine particles larger than the first insulating fine particles, a surface of the insulating fine particle layer having a projection formed from the second insulating fine particles; and
a second electrode formed on the insulating fine particle layer,
wherein when a voltage is applied between the first electrode and the second electrode, electrons provided from the first electrode are accelerated in the insulating fine particle layer to be emitted from the second electrode via the projection.

2. The electron emitting element according to claim 1, wherein the insulating fine particle layer includes a first part formed from the first insulating fine particles and a second part formed from the first and second insulating fine particles, and the projection are formed in the second part.

3. The electron emitting element according to claim 1, wherein the first insulating fine particles have an average particle diameter of 7 nm to 400 nm.

4. The electron emitting element according to claim 2, wherein the first part has a layer thickness of 1 μm or less.

5. The electron emitting element according to claim 1, wherein the second insulating fine particles have an average particle diameter of 9 or more times the average particle diameter of the first insulating fine particles.

6. The electron emitting element according to claim 1, wherein the first and second insulating fine particles are formed of at least one insulator of SiO₂, Al₂O₃ and TiO₂.

7. The electron emitting element according to claim 1, wherein the first and second insulating fine particles contain an organic polymer.

8. The electron emitting element according to claim 1, wherein the insulating fine particle layer is formed by applying a dispersion of the first and second insulating fine particles that are surface-treated.

9. The electron emitting element according to claim 1, wherein the second electrode is formed of at least one metal of gold, silver, tungsten, titanium, aluminum and palladium

10. An air blowing device comprising the electron emitting element according to claim 1, wherein electrons are emitted from the electron emitting element to generate ion wind.

11. A cooling device comprising the electron emitting element according to claim 1, wherein electrons are emitted from the electron emitting element to cool an object.

12. A charging device comprising the electron emitting element according to claim 1, wherein electrons are emitted from the electron emitting element to charge a photoreceptor.

13. An image forming apparatus comprising the charging device according to claim 12.

14. An electron emitting device comprising the electron emitting element according to claim 1 and a power supply for applying a voltage between the first electrode and the second electrode.

15. The electron emitting device according to claim 14, wherein the electron emitting device include a power supply for applying a voltage between the first electrode and the second electrode.

16. A method for producing an electron emitting element which includes: a first electrode; an insulating fine particle layer formed on the first electrode; and a second electrode formed on the insulating fine particle layer, wherein the insulating fine particle layer comprising first insulating fine particles and second insulating fine particles larger than the first insulating fine particles, a surface of the insulating fine particle layer having a projection formed from the second insulating fine particles, electrons provided from the first electrode being accelerated in the insulating fine particle layer to be emitted from the second electrode via the projection, when a voltage is applied between the first electrode and the second electrode,
the method comprising the steps of: forming the insulating fine particle layer composed of the first and second insulating fine particles on the first electrode; and forming the second electrode on the insulating fine particle layer and opposite the first electrode,
wherein the step of forming the insulating fine particle layer includes a step of applying a dispersion of the first and second insulating fine particles onto the first electrode.

17. The method for producing the electron emitting element according to claim 16, wherein the first and second insulating fine particles in the step of forming the insulating fine particle layer are surface-treated insulating fine particles.
